(19) United States
(12) Patent Application Publication
(10) Pub. No.: US 2008/0265219 A1
(43) Pub. Date: Oct. 30, 2008

(54) Method for Fabricating Intrinsically Conducting Polymer Nanorods

(76) Inventors: Michael Anthony Whitehead, Montreal (CA); Cecile Malardier-Jugroot, Kingston (CA); Theodorus G.M. Van De Ven, Sainte-Adele (CA); Thomas Dominic Lazzara, Lasalle (CA)

Correspondence Address: GOUDREAU GAGE DUBUC, 2000 MCGILL COLLEGE, SUITE 2200, MONTREAL, QC, H3A 3H3, CA

(21) Appl. No.: 11/569,893

(22) PCT Filed: Jun. 1, 2005
(86) PCT No.: PCT/CA05/00833

§ 371 Date: Dec. 1, 2006

Related U.S. Application Data
(60) Provisional application No. 60/575,367, filed on Jun. 1, 2004.

(51) Int. Cl. H01B 1/00

(52) U.S. Cl. 252/511

(57) ABSTRACT

A method for synthetizing nanorods, comprising using self-assembled defect free nanotubes formed in water at room temperature and the nanorods are synthesised within the nanotubes in water at room temperature. The size of the nanorods obtained is well defined due to the well-defined size of the self-assembled nanotubes. In addition, the nanorods synthesised by this method may be doped to improve the conductivity and to obtain p and n nanowires.

### FIELD OF THE INVENTION

The present invention relates to conducting nanorods. More specifically, the present invention is concerned with a method for fabricating intrinsically conducting polymer nanorods.

### BACKGROUND OF THE INVENTION

As a limit of silicon based electronic devices is foreseen, new technologies are being developed toward nanoscale electronic devices. Nanotechnology is currently considered as very promising, for example in the field of information storage and retrieval, and for the construction of extremely small computers and electronic devices with a wide range of applications.

One of the keys in the making of nano devices is the fabrication of conducting nanorods, sometimes referred to as nanowires, in a controlled and cost effective way. The fabrication of nanorods is currently understood as involving the use of self-assembling nanostructures.

A known method for synthetizing nanorods using block polymer templates (see Thurn-Albrecht T., Schotter J., Kästle G., Emley N., Shibauchi T., Krusin-Elbaum L., Guarini K., Black C., Tuominen M., Russell T., “Ultrahigh-Density Nanowire Arrays Grown in Self-Assembled Diblock Copolymer Templates” Science, 2000), includes using a well defined organized system like polystyrene (PS)/polymethylmethacrylate (PMMA) forming cylindrical hexagonal lattice. Orientation of the cylinders is achieved by applying a field across electrodes positioned above and below the polymer film. Then, the PMMA is degraded by UV irradiation and selectively removed by acid rising. Nanorods may be obtained by electrodeposition of copper or cobalt in the pores of the PS matrix from a methanol solution, which has proven to yield well-defined nanorods. However, such a method involves a plurality of steps and the resulting nanorods are fixed in the polymer matrix.

Nanorods may also be produced using block copolymer lithographic methods, which allow obtaining high-density arrays (see Cheng J. Y., Ross C A, Chan V. Z-H., Thomas E. L., Lammertink R. G. H. and Vancso G. J., 2001 Adv. Mater. 13 1174). However, such methods also involve a plurality of steps and prove to be difficult to implement for mass production.

Fabrication of nanorods needs to be easy, cost effective, allowing fabrication of densely packed, defect free nanorods, in an environmentally friendly way.

Intrinsically conducting polymers (known as ICP's) such as polypyrrole, polythiophene and polyaniline for example, are of primary interest due to their wide applications. Some commercially viable applications include for example the following: organic light-emitting diodes (LED) (see Yu, G.; Heeger, A. J. Synth. Met 1997, 85, 1183) and display (see F. Roussel, R. Chan-Yu-King, J. M. Buisine, Eur. Phys. J. E, 2003, 11, 293-300); electrochromic windows (Sapp, S. A.; Sotzing, G. A.; Reynolds, J. R. Chem. Mater. 1998, 10, 2101-2108); volatile organic light sensors (MaQuade, D. T.; Pullen, A. E.; Swager, T. M. Chem. Rev. 2000, 100, 2537-2574; Sotzing, G. A.; Briglin, S.; Grubbs, R. H.; Lewis, N. S. Anal. Chem. 2000, 72, 3181); energy storage batteries (Ferraris, J. P.; Eissa, M. M.; Brotherston, I. D.; Loveday, D. C. Chem. Mater. 1998, 11, 3528-3535); non linear optics for use in telecommunications (Ma, H.; Chen, B.; Sassa, T.; Dalton, L. R.; Jen, A. K.-Y. J. Am. Chem. Soc. 2001, 123, 986-987); protective coatings for corrosion prevention (Perucki, M.; Chandrasekhar, P. Synth. Met. 2001, 119, 385-386; P. T. Nguyen, U. Rammelt, W. Plieth, J. Solid State, Electrochem., 2003, 7, 497-502); charge dissipating films (Lerch, K.; Jonas, F.; Linke, M. J. Chim. Phys. Phys.-Chim. Biol. 1998, 95, 1506) and antistatic dissipation; capacitors, photoconductors for xerography for example; chip fabrication; actuators; radio-frequency-interference shielding (EMI); electromagnetic-interference shielding (RFI); conductive fabrics; conducting paper; and controlling the conductivity of the paper.

ICP technology is presently a most innovative technology because ICP's materials combine properties of metals and plastics. Existing or expected advantages over metals or inorganic semiconductors include, for example, the following: a higher electrical conductivity or a tailor-made conductivity under a given set of plasticity; plasticity and elasticity; a low mass density; a low heat conductivity; a low coefficient of expansion; resistance to chemicals and corrosion; an anisotropic (axial) molecular structure and conductivity; and tunable optical properties.

Nanotubes can be made from alternating copolymers. An example is poly(styrene maleic anhydride) (SMA), a polymer in which a hydrophobic styrene group alternates with a hydrophilic anhydride group. Its properties are strongly dependent on pH, because the maleic anhydride group opens in water, forming two carboxyl groups, wherein a degree of dissociation of these two groups depends on pH: at low pH, these two groups are protonated and SMA is a neutral polymer; at intermediate pH around 7, a first group is dissociated and a second group is protonated; and at high pH around 12, both groups are dissociated. In water SMA forms association complexes with itself at intermediate pH's (G. Garnier, M. Duskova-Smrckova, R. Vyhnalkova, T. G. M. van de Ven, J-F. Revol, Association in Solution and Adsorption at an Air-water Interface of Alternating Copolymers of Maleic Anhydride and Styrene, Langmuir, 2000, 16, 3757-3763). The size of these complexes is typically of the order of microns.

Molecular modeling of SMA has shown that at intermediate pH, when only one of the carboxyl groups is dissociated, an internal hydrogen bond is formed between the hydrogen atom of the protonated carboxyl group and the oxygen atom on the other carboxyl group (C. Malardier-Jugroot, T. G. M. van de Ven, M. A. Whitehead, Conformation of Poly(Styrene-Maleic Anhydride) at different pH Values: Formation of Nanotubes in Solution; Proceedings of 5^{th} international Paper and Coating Chemistry Symposium 2003, submitted to Molecular Simulation). This internal H-bond stiffens the structure and provides a periodic spacing between neighboring styrene groups, in between which styrene groups of other molecules can fit. Because styrene groups stick out from the backbone of the molecule in two directions, therefore other molecules can associate with the molecule from two sides, resulting in chains consisting of several SMA molecules “zipped” together.

In spite of recent developments, there is still room in the art for a method for fabricating intrinsically conducting polymer nanorods.

### SUMMARY OF THE INVENTION

More specifically, there is provided a method for fabricating intrinsically conducting polymer nanorods a method for fabricating intrinsically conducting polymer nanorods, comprising the steps of making nanotubes; filling the nanotubes with a monomer; and polymerizing the monomer inside the nanotubes.

There is further provided intrinsically conductive polymer nanorods comprising a nanotubes filled with a monomer, the monomer being polymerized inside the nanotubes.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a representation of a Tree Branch method of optimisation;

FIG. 2 is a representation of a series of scans in energy method of optimisation;

FIG. 3 illustrates conformations at pH 3, 7 and 12 of the monomer of SMA at an ab-initio level of theory, wherein binding sites of the monomer at pH3 and 12 are identical;

FIG. 4 is a schematic representation of a substitution method;

FIG. 5 shows different conformations of the quadrimer of SMA at pH 3 corresponding to two chiralities (SR RR SR and SR SR SR), wherein a first structure has a step-like conformation and a second has a well-like conformation;

FIG. 6 is a representation of an association between two chains of different chirality at pH 3;

FIG. 7 shows two different conformations of a quadrimer of SMA at pH 7 corresponding to two chiralities (SR RR SR and SR SR SR), displaying very linear structures and similar orientations of the benzene groups;

FIG. 8 shows two different conformations of a quadrimer of SMA at pH 12 corresponding to two chiralities (SR RR SR and SR SR SR), wherein a first structure has a step-like conformation and a second has a well-like conformation;

FIG. 9 shows a front view and a side view of a configuration of a tubular association of SMA dodecamers at pH 7 at a molecular mechanical level;

FIG. 10 schematic illustrates growth of the SMA association at pH7 in a radial and a longitudinal directions;

FIG. 11 shows a Cryo-TEM picture of the association of SMA in solution at pH7 (Mw=1600), where the lines represent directions of the tubular association of SMA.

FIG. 12 is a schematic representation of an hollow cylinder model;

FIG. 13 shows neutron scattering profile of a 1% wt solution of SMA (Mw=40K) in D₂O (open circles) and fit (full line);

FIG. 14 shows neutron scattering profiles of a 2% wt and 5% wt solutions of SMA (Mw=40K) in D₂O (open circles) and fit (full line);

FIG. 15 is a graph of log(I (Q)) versus log(Q) at low Q values for a 1% wt solution of SMA 1600 in D₂O;

FIG. 16 compares of structure of (a) SMA (pH 7) and (b) SMI (pH 7);

FIG. 17 compares the optimized structures of SMA (left) and SMI (right) where there is similarity in the critical linking position that allows linear polymers to form;

FIG. 18 shows structural similarity between the SMA and SMI dimers, the angle between the two phenyl groups and their orientation being similar;

FIG. 19 shows structural similarity between the SMA and SMI trimers with respect to the phenyl group alignment, the phenyl groups aligning in a parallel manner in the polymer to allow π-π interactions between SMI chains;

FIG. 20 illustrates control of the shape, the size and the length of the SMA association using structural modification of the polymer and surface treatment optimized by theoretical methods;

FIG. 21 shows neutron scattering profiles of a 1% wt solution of EE-SMA at pH 7 (Mw=40K);

FIG. 22 shows side view (a) and front view (b) of the delocalised molecular orbital number 165 (E=−0.546 eV);

FIG. 23 illustrates the polymerization of the monomers inside a tube of SMA in water;

FIG. 24 illustrates a method for nanorods synthesis into a 1 wt % SMA solution at pH 7;

FIG. 25 is a Cryo-TEM picture of the association of SMA/polypyrrole nanorods in solution at pH 7, the lines representing a direction of the tubular association of SMA;

FIG. 26 is a schematic representation of adsorption of the nanorods onto a mica-polylysine surface;

FIG. 27 shows AFM pictures of one SMA/polypyrrole nanorods at pH 7, where the second AFM picture is a magnification of the first picture shows pictures;

FIG. 28 shows a neutron scattering profile of a 1% wt SMA solution (Mw=40K) in D₂O (full circles) compared to a 1% wt SMA solution filled with polypyrrole in m_{d5-pyr} (empty circles);

FIG. 29 shows neutron scattering profiles of a 2% wt SMA solution filled with 0.03 ml of pyrrole (open circles) and an excess of pyrrole (open triangles) in m_{SMA};

FIG. 30 illustrates conductivity measurements of the solution of SMA-polypyrrole;

FIG. 31 illustrates nanorods forming crossbar nanorod structure by using an electric field; and

FIG. 32 illustrates an association of two different tubes for the synthesis of two different alternating nanorods.

### DESCRIPTION OF EMBODIMENTS OF THE INVENTION

There is provided a method for fabricating electrically conducting polymeric nanorods including filling nanotubes with monomers, followed by polymerization of the monomers.

The nanotubes are made from alternating copolymers of SMA (styrene maleic anhydride) or derivatives thereof, in water at room temperature.

Poly(styrene-maleic anhydride) (SMA) is a water-soluble polymer, which is highly pH dependent due to a maleic anhydride ring thereof. Differences in pH in an SMA solution therefore yield different structures for the polymer due to different degrees of ionization of the molecule. A modelization of the different structures at different pH may be achieved using the different degrees of ionization of the polymer in solution.

The conformation of the monomer may be obtained using two methods developed elsewhere by the present inventors as (i) the Tree Branch Method (Villamagna, F.; Whitehead, M. A.; “Comparison of complete conformational searching and the energy-optimized tree branch method in molecular mechanics calculations.” J. Chem. Soc., Faraday Trans., 1994, 90(1), 47-54); and (ii) a series of scans in energy (see Malardier-Jugroot, C.; Spivey, A. C.; Whitehead, M. A.; “Study of the influence of the non-pyridyl nitrogen hybridization on the stability of axially chiral analogues of 4-(dimethylamino)pyridine (DMAP)” J. Mol. Struc. (THEOCHEM) 2003, 623, 263-276; HyperChem release 5.11 (1999) for Windows molecular modeling system, Hypercube Inc., 419 Philip St., Waterloo, Ont., Canada, N2L 3X2; Gaussian 98W (Revision A.5), Frisch, M. J.; Trucks, G. W.; Schlegel, H. B.; Scuseria, G. E.; Robb, M. A.; Cheeseman, J. R.; Zakrzewski, V. G.; Montgomery, J. A.; Stratmann, R. E.; Burant, J. C.; Dapprich, S.; Millam, J. M.; Daniels, A. D.; Kudin, K. N.; Strain, M. C.; Farkas, O.; Tomasi, J.; Barone, V.; Cossi, M.; Cammi, R.; Mennucci, B.; Pomelli, C.; Adamo, C.; Clifford, S.; Ochterski, J.; Petersson, G. A.; Ayala, P. Y.; Cui, Q.; Morokuma, K.; Malick, D. K.; Rabuck, A. D.; Raghavachari, K.; Foresman, J. B.; Cioslowski, J.; Ortiz, J. V.; Stefanov, B. B.; Liu, G.; Liashenko, A.; Piskorz, P.; Komaromi, I.; Gomperts, R.; Martin, R. L.; Fox, D. J.; Keith, T.; Al-Laham, M. A.; Peng, C. Y.; Nanayakkara, A.; Gonzalez, C.; Challacombe, M.; Gill, P. M. W.; Johnson, B. G.; Chen, W.; Wong, M. W.; Andres, J. L.; Head-Gordon, M.; Replogle E. S.; and Pople, J. A.; Gaussian, Inc., Pittsburgh Pa., 1998)

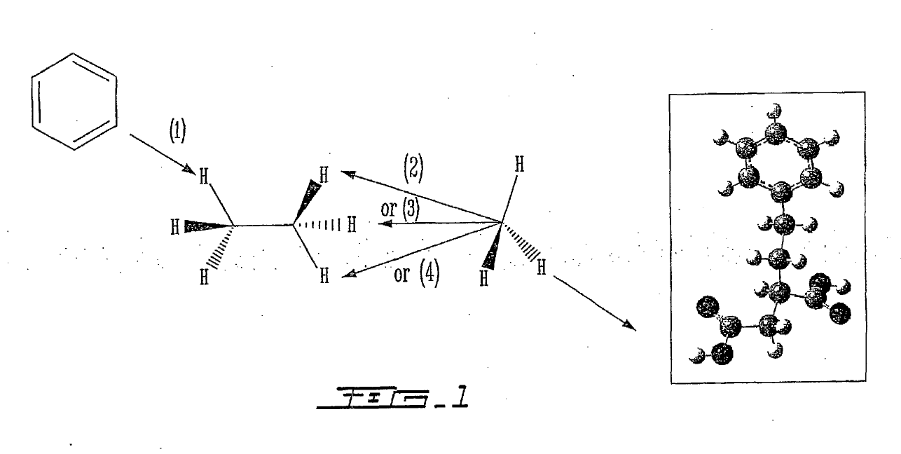

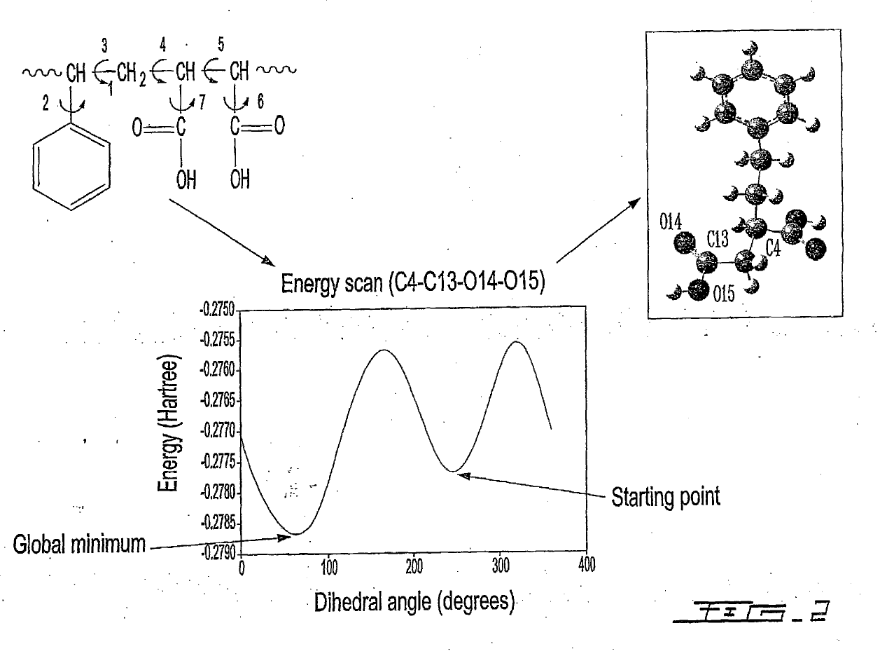

As illustrated in FIG. 1, the Tree branch method comprises adding part by part groups composing the molecule starting from a known structure. The second method uses a series of scans in energy to find a most stable molecule for each dihedral angle in the molecule. The scans are performed one by one and a most stable structure obtained within one scan is used as a starting structure for a next scan, as illustrated in FIG. 2.

Conformational studies of the monomers are performed at a semi-empirical level of theory, the structures then being reoptimized at an ab-initio level of theory. Structures optimised at three different pH are shown in FIG. 3. It is to be noted that similar conformations are obtained using both methods described hereinabove.

From the structures obtained for different pH, it appears that at pH7 the presence of a hydrogen bond changes the geometry of the ground state from pH3 to pH7. This hydrogen bond is very strong (1.68 Å) compared to a typical hydrogen bond found between two water molecules (1.80 Å).

The structure of the oligomers is then optimized using similar methods, and obtained conformations thereof for different pH values are compared.

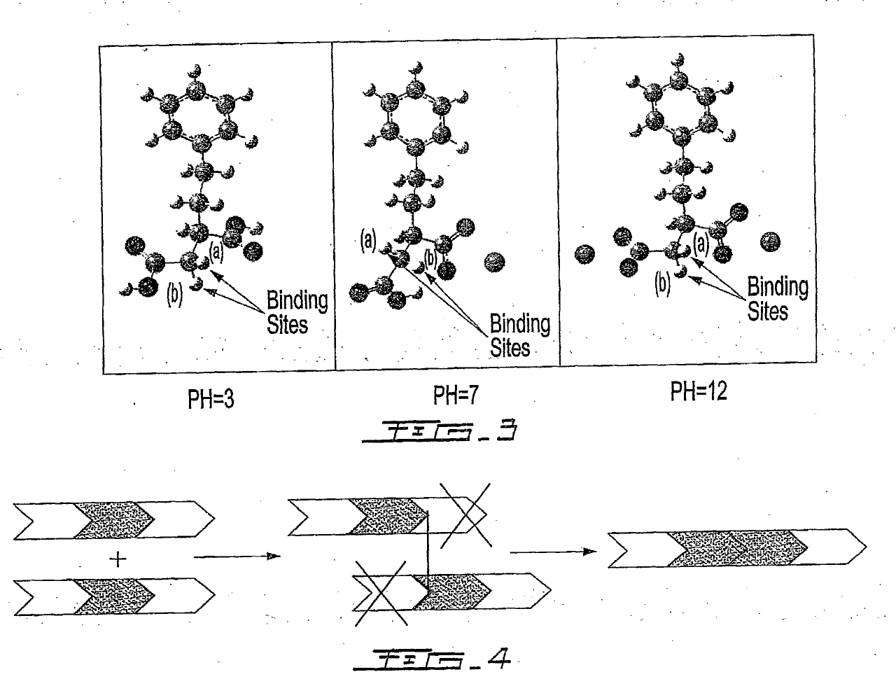

To optimize the quadrimer structure at pH 3, scans in energy may be used, wherein all degrees of freedom of the molecule are optimized, or a faster method, referred to as a substitution method, may be used, wherein two trimers form a quadrimer based on the fact that a second monomer is constrained by a monomer and a third monomer and therefore has a same constraint and interaction as a monomer in the middle of a polymer chain (FIG. 4). From this observation, the quadrimer conformations are built directly from two trimer structures and then optimized using a semi-empirical approach and compared to the same molecule obtained with the scans. Since the molecules obtained are very similar using the two methods, the substitution method is chosen to build the complete library of structures with different chirality. This method proves to be very useful for optimizing long polymer chains with different chirality.

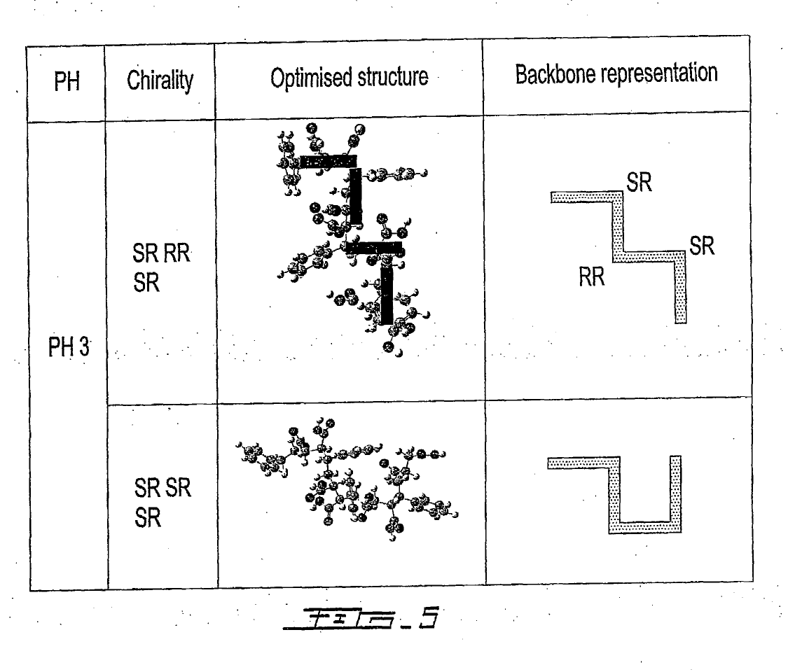

It is found that the different conformations obtained for the trimer at pH 3 have a U or a Z shape structure depending on the chirality of the oligomer chain. This difference in configuration is also observed in the quadrimer conformation. In FIG. 5, two quadrimers with different chirality are shown, a first one being SR-RR-SR and a second one being SR-SR-SR, wherein these two polymers differ only by one junction in the middle of the molecule. This difference causes a rotation, around the junction, whereby the conformation changes from a step-like conformation to a well-like conformation, as may be observed in the backbone representation of the quadrimer in FIG. 5.

Since the chirality of the polymer is not controlled during the synthesis of SMA, the polymer under study may have different chirality between each monomer along the chain. The difference in conformation due to the change in chirality of the molecule implies that two chains with different chirality do not associate along the polymer chains, and only a very weak interaction between two benzene rings is possible (FIG. 6). These results are in agreement with DLS studies where little or no association is observed at low pH. Due to a self-avoidance problem often encountered by non-linear polymers as known in the art, the structures at pH 3 for oligomers larger than quadrimers are difficult to obtain. Indeed the substitution model is not applicable when the self-avoidance occurs within a structure and therefore only a complete optimization using scans would be accurate. However, such a complete optimization is prohibitively time consuming for molecules larger than quadrimers to obtain the complete library of structures with different chirality. Therefore, oligomers larger than quadrimers for structures at pH 3 are not optimized herein since the chirality dependence of the polymer has already been proven by the study of the different trimers and quadrimers.

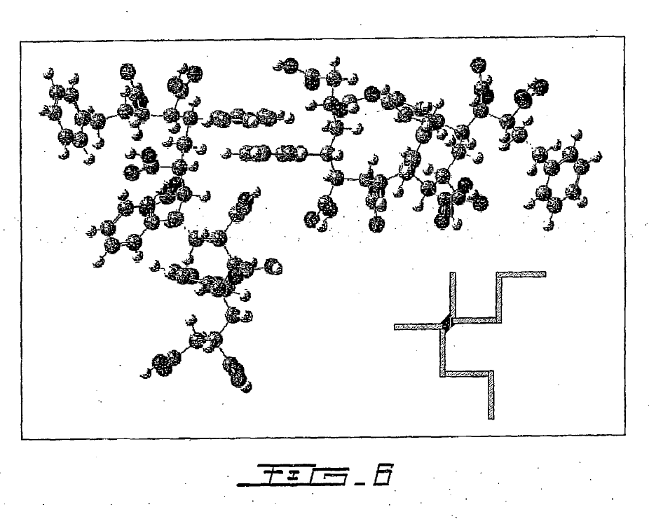

For the optimisation of the quadrimer conformations at pH7, similar methods are used and the structures obtained are compared. Since the molecules obtained are very similar, the substitution method is chosen to build the complete library of structures with different chirality's. Two configurations with different chirality are shown in FIG. 7. The structures obtained are very linear and orientations of the benzene groups of the different oligomers obtained are identical. In addition, the quadrimer conformations at pH7 show a repetition of a same monomer orientation from the quadrimer and therefore the repetitive unit for SMA at pH7 can be defined as three monomer units. Since the orientation of the benzene groups are very similar along the polymer chain, regardless of the chirality, two chains may associate by stacking interactions of the benzene rings.

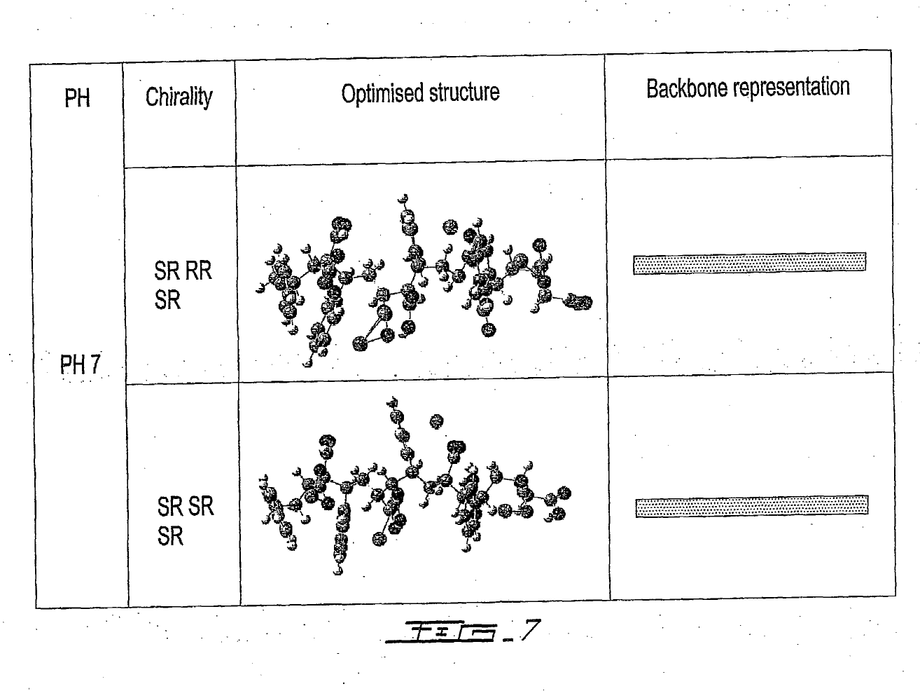

As may be seen in FIG. 8, the conformations of the quadrimer structures with different chirality at pH 12 are very similar to the conformations obtained at pH 3. The interaction between the hydrophilic groups of the monomer observed in the monomer conformation at pH 12 is still present in the quadrimer structure. Due to this change in conformation with different chirality, the polymer is achieved between the chains at pH 12. This theoretical prediction is in agreement with DLS observations. As explained hereinabove, oligomers larger than quadrimers for structures at pH 12 are not optimized, as the chirality dependence of the polymer has already been proven by the study of the different trimers and quadrimers.

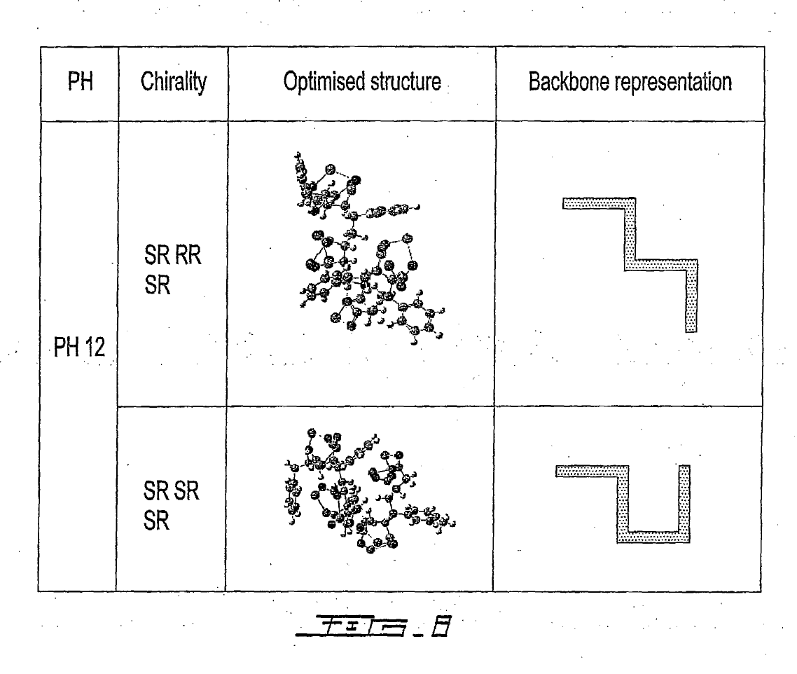

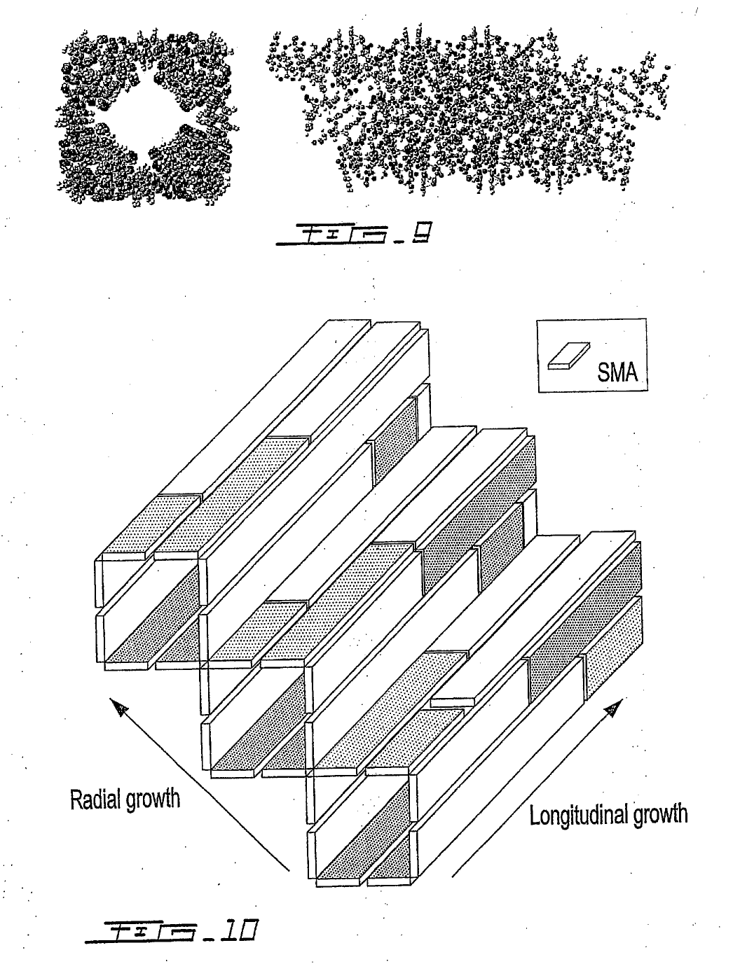

Since association between two chains at pH7 forms a 90° angle, a tube may be formed by associating eight (8) SMA molecules, a front view of this tube being a square due to the angle between two chains. The association is growing like a helix inside to form the tube. This association is studied using molecular modeling and the most stable is found to be a tubular conformation where the inside of the tube is mainly hydrophobic whereas the exterior is mainly hydrophilic (FIG. 9). The diameter of the tube cavity is determined to be about 28 Å and the external diameter about 41 Å. The tubular structure is maintained by stacking interactions between the benzene groups of poly(styrene-maleic anhydride), which is herein studied in the gas phase, and therefore seems to be stable in water. Indeed the interactions occurring between the chains are hydrophobic interactions hence protecting the benzene groups from contact with water. In addition this association may grow in two directions: within the tube to increase the length and also between the tubes to increase the width (FIG. 10).

In summary, it is found that the structure with the lowest energy consists of nanotubes, in which eight (8) SMA chains form a loop of a helix. The structure of such a helix, obtained from molecular mechanics calculations, is shown in FIG. 9. It is shown that the interactions between the chains are hydrophobic π-π interactions and are stable. Since the interior of the tubes is mainly hydrophobic and the exterior is mainly hydrophilic, it is possible to fill the tube with hydrophobic molecules.

Cryo-electron-microscopy confirms the presence of regular spacing with a dimension corresponding to the theoretical size of the nanotubes (27 Å). In a cryo-TEM experiment, a drop of a solution of SMA at pH7 is refrigerated under liquid nitrogen. The top of the frozen sample is then cut and a replica of the surface is obtained by spraying a PVC mixture at 45° with respect to the surface and then by spraying C normal to the surface. Very long lines associated with a diameter of about 50 Å, which corresponds to the theoretical calculations, are thus seen. These lines are organized in sheets one on top of the other with the lines of one sheet making an angle of 45° with the other sheet (FIG. 113). This angle is due to the stacking interaction between benzene groups, which make a 45° angle with a main axis of the tube.

Using the structure of SMA chains association in solution obtained hereinabove, a model is developed, which uses a form factor for cylinders, as known in the art. To define a hollow cylinder, the form factors of two coaxial cylinders are combined, wherein a first cylinder represents the shell of the tube and has the scattering length of the polymer studied, and a second cylinder represents the solvent inside the hollow cylinder and has the scattering length of the solvent, as shown in FIG. 12. In addition, since it has been shown hereinabove that the tubes formed by SMA chains are not independent, in good agreement with the shape of the scattering curve obtained for SMA as an increase at low Q values, an interaction between the two hollow cylinders is modeled using a potential. People in the art will realize that this model is an approximate representation of the interaction predicted by the theoretical calculation and observed by cryo-TEM, since it neglects the effect of the packing of the sheets upon each other; as a result, deviation from the experimental curve for large scale interactions may be expected.

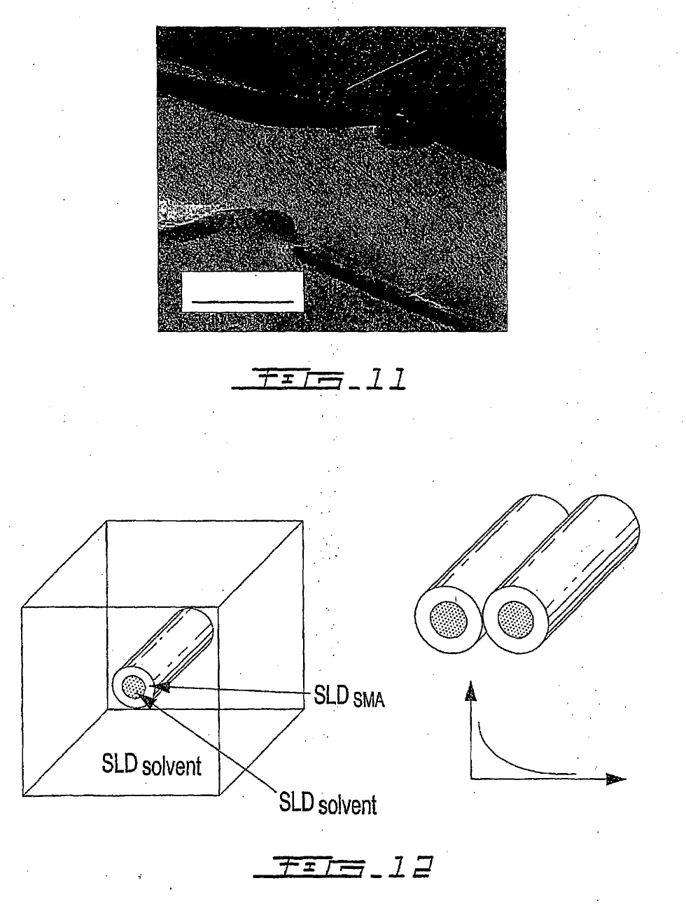

Several parameters, including the calculated SLD of the solvent and of the polymer, and the total volume fraction, used to fit the experimental curves are known and therefore fixed during the optimization of the unknown parameters. Theoretical inner and outer radii of the tube are used as a starting point for the optimization of the model form factor. The fit and experimental data for the 1% wt SMA solution is in FIG. 13. This fit (full line) shows a very close agreement with the experimental curve (circles). Indeed, a peak is observed for Q ˜0.05 Å⁻¹ and an increase at low Q value is also predicted by the model. Although the fit obtained with this model is explained by the neglect of the packing between the sheets. The internal and external radii found during the optimization of the parameters of the model form factor are very close to the theoretical prediction, as may be seen in Table I below. The external radius found by this method (19.7 Å) is very good agreement with theory (20.5 Å).

TABLE I
Experimental and theoretical inner and outer radii.

| | Theory | Experiment |
|---|---|---|
| Inner radius (Å) | 14.0 | 12.8 |
| Outer radius (Å) | 20.5 | 19.7 |

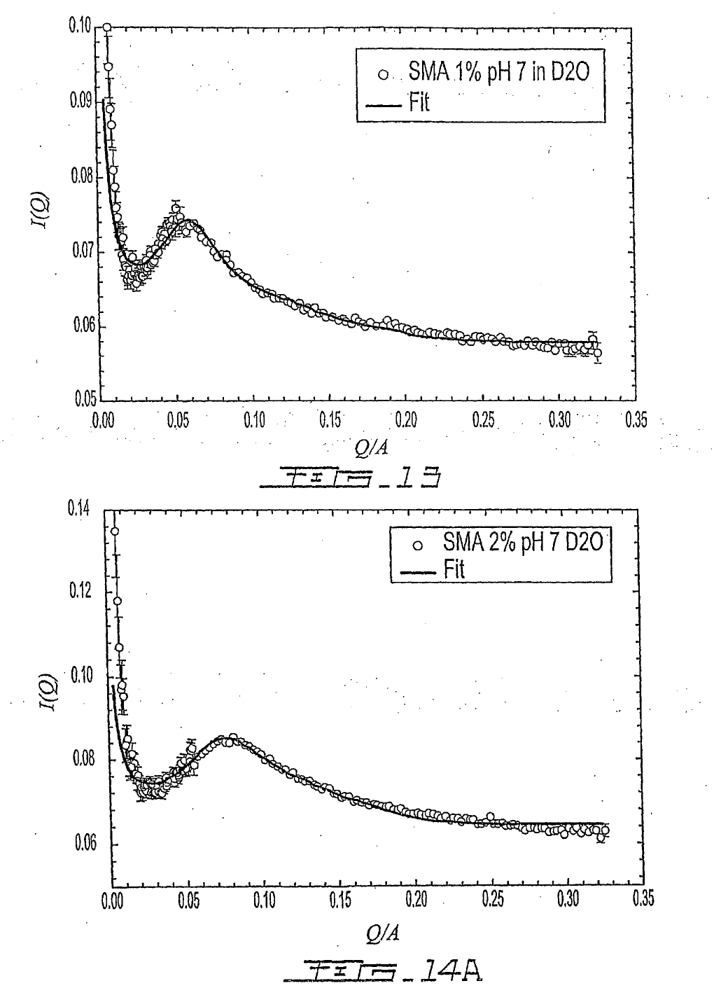

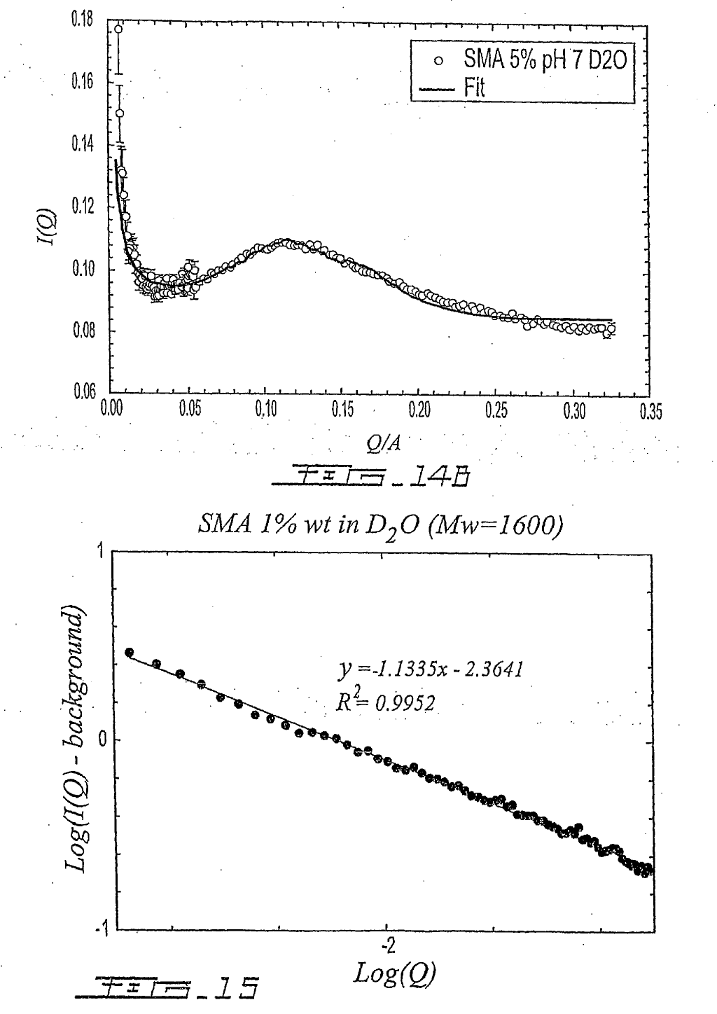

For the optimization of the solutions at other concentrations, the same fixed parameters are used and the total volume fraction is taken as a function of concentration. The hollow cylinder model is used for the fitting of 2% wt and 5% wt solutions and the experimental profiles as well as the fitted radii are shown in FIG. 14. The Table II below shows the corresponding experimental and theoretical inner and outer radii.

TABLE II

| | Theory | Experiment | Theory | Experiment |
|---|---|---|---|---|
| Inner radius (Å) | 14.0 | 12.8 | 14.0 | 12.7 |
| Outer radius (Å) | 20.5 | 22.3 | 20.5 | 22.3 |

To study a molecular weight dependence, a plot of log(I (Q)) versus log(Q) is drawn at low Q values for the 1% wt solution of SMA in D₂O corresponding to a molecular weight of 1600 has a slope of −1.13, which corresponds closely to a slope of −1 expected for isolated rods, as shown in FIG. 15. As the absolute value of the slope is greater than 1, the presence of sheets observed for the higher molecular weight is possible. The sheets are observed by Cryo-TEM for a 1% solution of SMA (Mw=1600).

The above modeling was extended to a copolymer, SMI (Styrene Maleimide), which has a similar structure to SMA, to see if it could also form a nanotube. Unlike the SMA copolymer, the SMI copolymer does not rely on a hydrogen bond to form the 5 member ring on the far right of the molecules because the nitrogen atom present closes the ring and makes a rigid structure. It is hoped that this would allow the formation of the nanotubes in any pH provided the electronegative chain could be solubilized in water. Also, because the backbone of the SMI is quite similar to that of the SMA, it is thought that there should not be much difference in the overall structure of SMI.

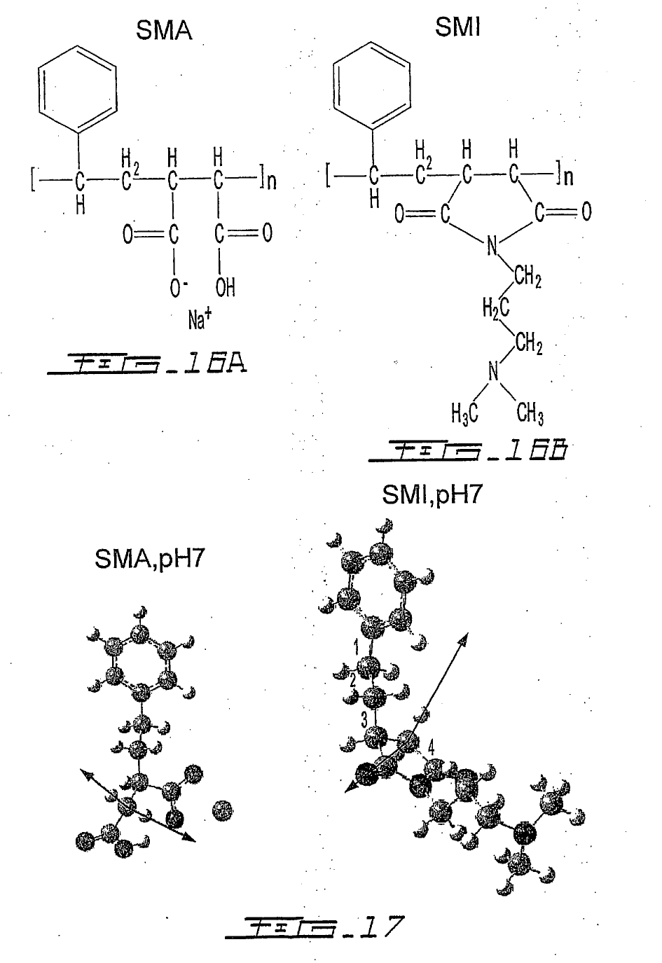

In a nanotube structure, similar to that of SMA, formed in SMI, the structure is built from the smallest repeat unit, the SMI copolymer. This unit is first optimized and then used as a building bloc to construct the polymer chains that interact and orient themselves to form a nanotube. The copolymer is optimized using PM3 calculations by rotating every dihedral angle and optimizing the global energy, for each minimum rotational energy found. It is found that that the structure of SMI is similar structurally to the structure of SMA at pH 7 that allows the formation of linear nanotubes. In SMI there is evidence from the monomer optimization that it has this special conformation that allows linear chains to form. The linear three carbons are present in SMI but are opposite in direction to the SMA carbons, with respect to carbon 2, FIG. 4. FIG. 17 shows this similarity and the difference in position. Therefore, it is strongly possible that these can form linear polymers just as the SMA does.

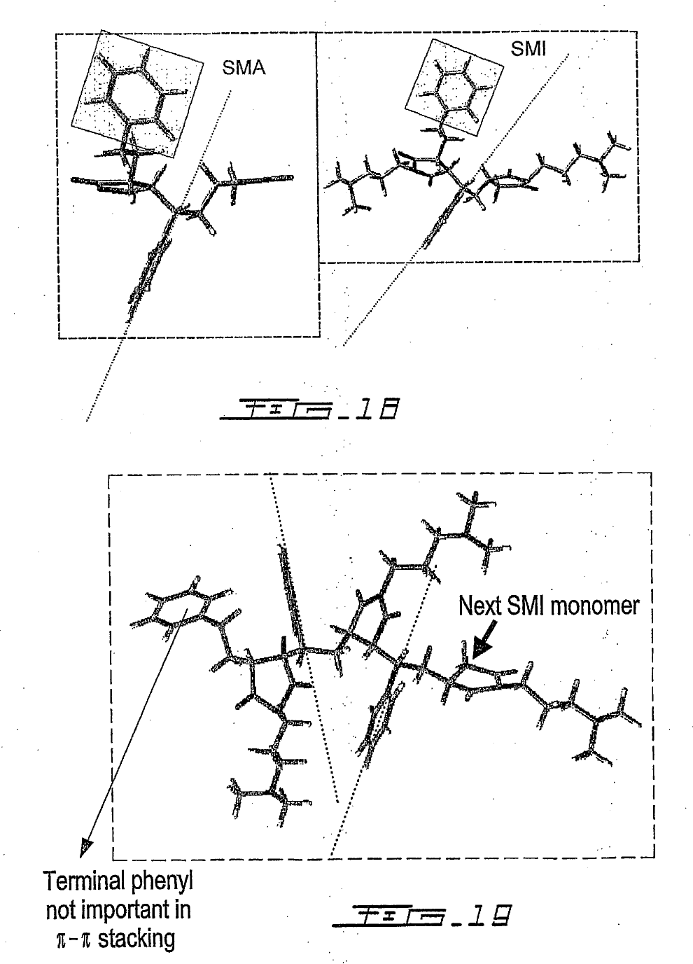

Early calculations on the SMI dimer and trimer reveal much similarity with the SMA dimer and trimer. Most importantly is that the phenyl groups have the same alignment as in the SMA case. For the dimer, both show the benzene rings perpendicular to each other. In the trimer, the phynyl groups are starting to align parallel to each other, which is critical for the π-π interaction that is required to hold the SMI polymer together and form a tubular structure; although the terminal benzene is unimportant given that is not required for the other π-π phenyl interactions to take place. FIGS. 18 and 19 show respectively for the dimer similarities and the phenyl group alignment in the trimer.

A method of synthesis of intrinsically conducting polymers according to the present invention will now be described.

The method of the present invention allows making nanorods from nanotubes, and comprises the steps of making nanotubes (step 12), filling the nanotubes with monomers (step 14), and polymerizing the monomers (step 16).

In step 12, self-assembling nanotubes are made from alternating copolymers. As mentioned hereinabove, it is shown from molecular mechanics calculations and from cryo-electron micrographs, that alternating copolymers may be made to form nanotubes of diameters of about 3 nm and with a length of several microns. To prevent the nanotubes from associating into sheets, the nanotubes are stabilized, either by polymer or polyelectrolyte adsorption or by chemically modifying the copolymers.

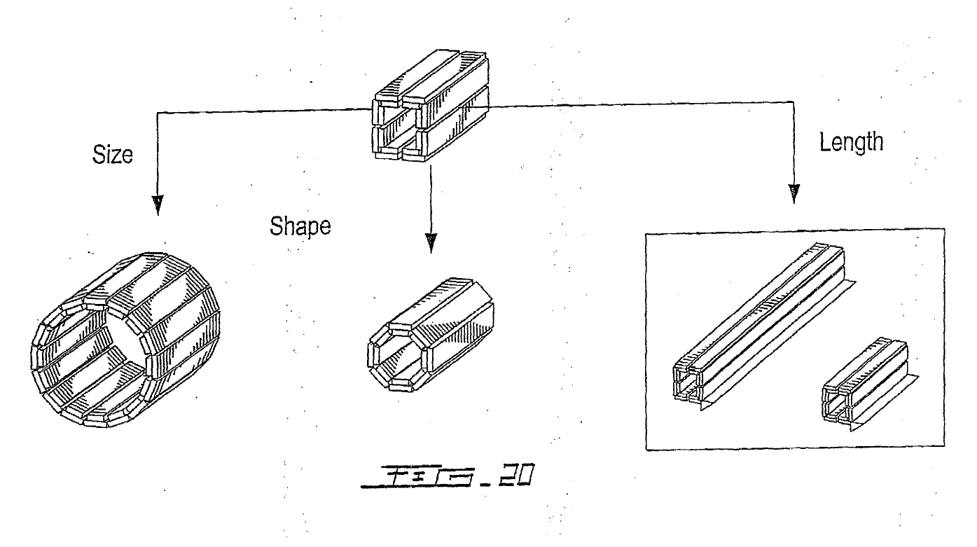

Optimum properties may be predicted from molecular mechanics and semi-empirical calculations of the self-assembly of alternating copolymers into nanotubes and of the effects of changing the chemistry of the polymers. The theoretical studies and the synthesis of the optimum SMA derivatives allow the design of tubes with controlled shape and size to design the nanorods (see FIG. 20). The nanotubes provide a type of matrix in which nanowires may be grown as now described.

To complete the investigation of the association of SMA chains in water at pH 7, a derivative of SMA is studied: the ethyl ester of SMA. The profile of the 1% wt EE-SMA solution in D₂O at pH 7 is shown in FIG. 21. This profile is very similar to the 1% wt SMA profile, as indeed the same increase at low Q value is observed. In addition the peak observed for the 1% wt SMA solution is also observed in this profile at the same Q value. The main difference between the two profiles is the intensity of the peak, which is more pronounced in the EE-SMA profile. Therefore a similar structure is expected for the association between SMA derivative chains and could be used for the synthesis of nanorods.

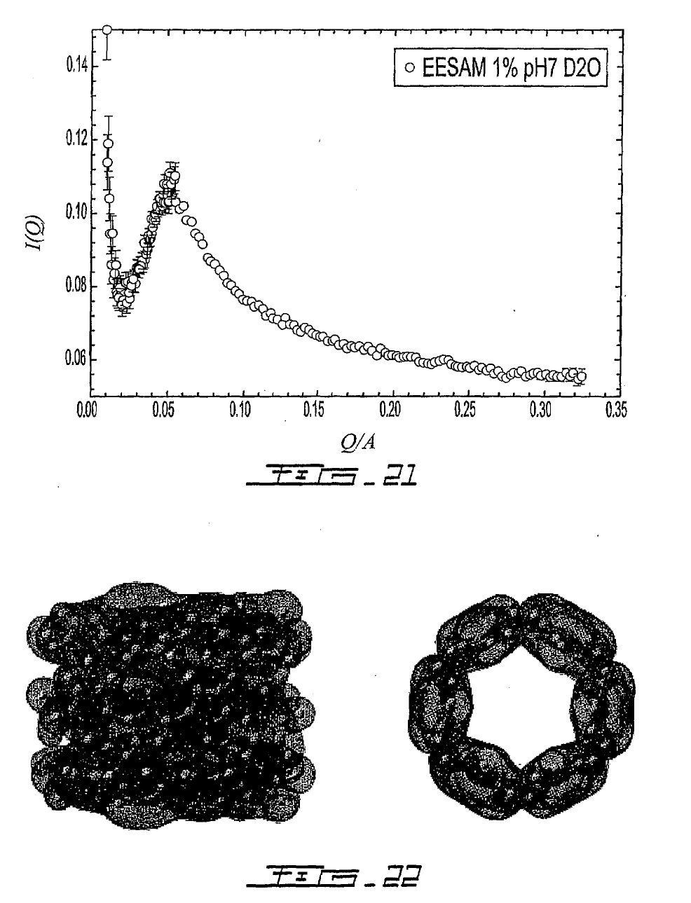

Furthermore, the orbital analysis of the closed structures show the same delocalisation found on the isolated octamer of polypyrrole with the same energy (FIG. 22). For the closed conformation containing 6 polypyrrole molecules, six degenerated delocalised molecular orbital were found with an energy of −0.546 eV; one of the orbitals is represented in FIG. 22. This delocalised molecular orbital shows no interactions between the different molecules and therefore the delocalisation is not disturbed by the other polypyrrole molecules of the complex. The delocalisation is essential for polymeric semi-conductor to transfer electrons and is efficient in a planar structure.

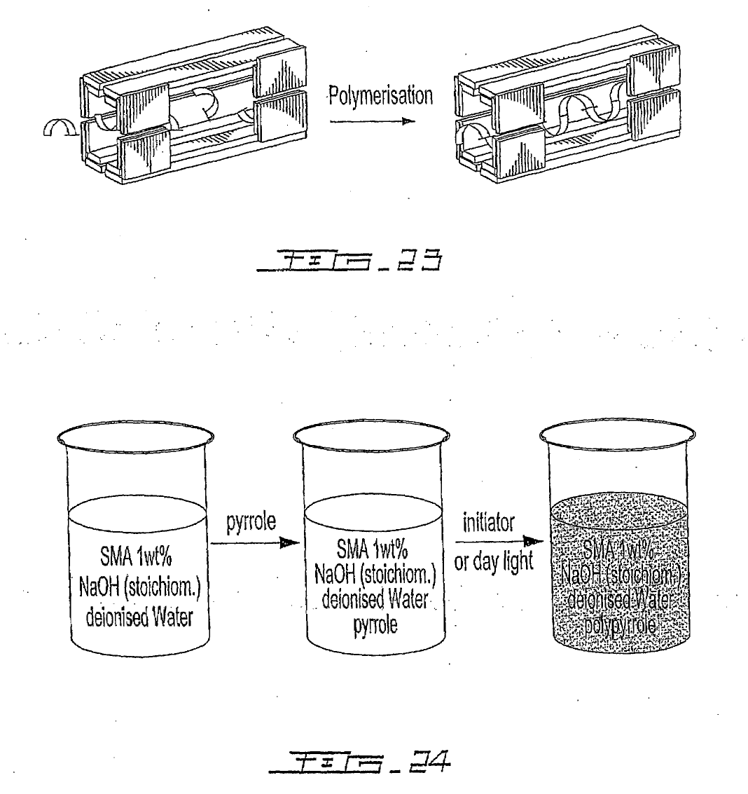

In steps 14 and 16, the nanotubes are filled with monomers that are polymerized into conducting polymer. A good candidate, among others is found to be pyrrole or thiophene. The polymers formed inside the tube are chiral due to the helical structure of the tube (see FIG. 23).

As illustrated in FIG. 24 in the case of pyrrole, the SMA polymer is added to water, the pH is adjusted with NaOH to pH7 (stoichiometric amount). The solution is then heated to 50° C. and sonicated. When the solution is clear the pyrrole is added. The dissolution of pyrrole in the SMA solution takes one day then an initiator can be added to the solution to polymerize the pyrrole or the reaction can be initiated by UV light. Using this technique, polypyrrole nanowires are obtained in solution. The polymerization of pyrrole is followed by a change in color of the solution. Furthermore, polypyrrole is known to be a water insoluble polymer, therefore only the presence of polypyrrole inside the nanotubes of SMA would explain the solubilisation of the polymer.

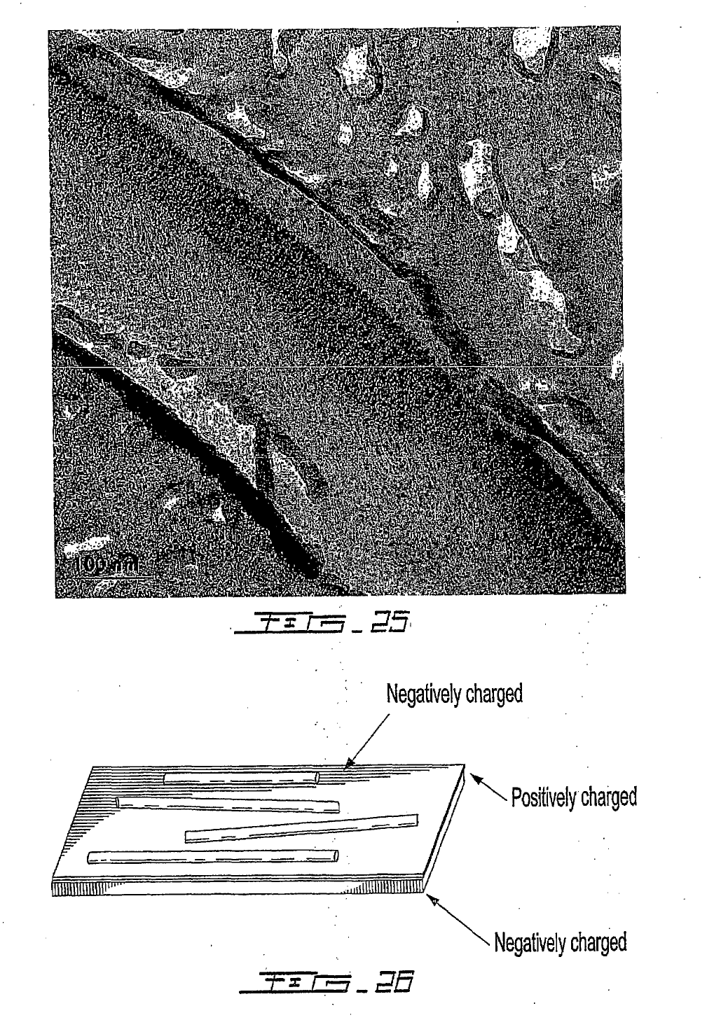

In order to observe the nanowires structures in water, cryo-TEM is performed. A drop of an aqueous solution of SMA-polypyrrole solution at pH 7 is refrigerated in liquid nitrogen, the frozen sample is cut, and a replica of the top surface is obtained by first spraying a platinum-carbon mixture at 45° with respect to the surface and then by spraying carbon normal to the surface. In preparing samples for cryo-TEM, the surface often fractures at locations were discontinuities in structure occur. The results obtained with this method for pH 7 show a very similar replica surface compared to the replica obtained for SMA solution at pH 7. The structure of the nanotubes of SMA seems unaffected by the presence of the polypyrrole. Therefore using this method for the synthesis of water-soluble nanowires, very dense arrays of nanowires can be obtained, as shown in FIG. 25.

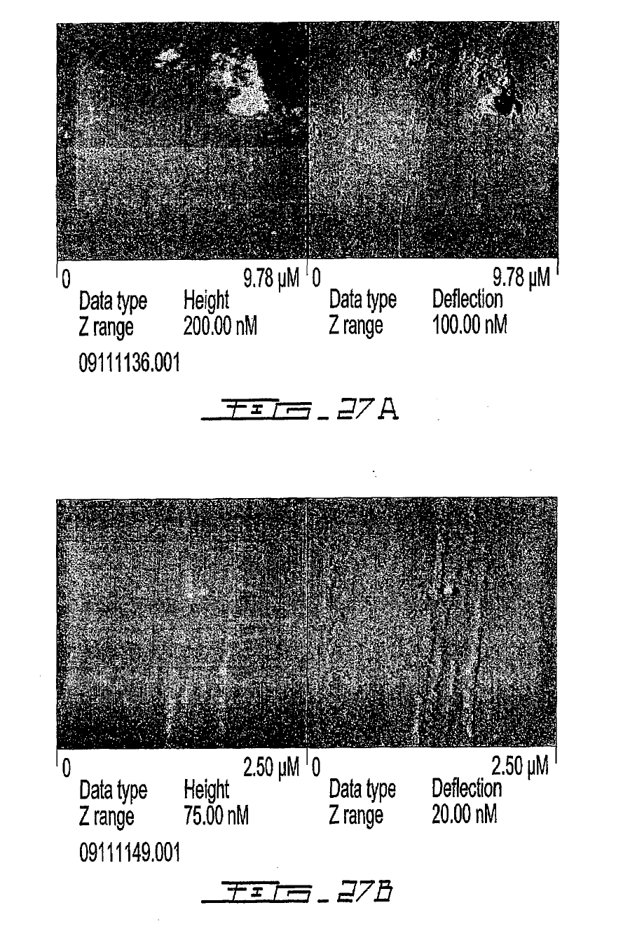

The tubular structure of SMA may be characterised by techniques using the adsorption of SMA onto a surface because the structure forms in water due to hydrophobic interactions and is disrupted when dried. The presence of polypyrrole inside the SMA tubes strengthens the structure and allows the characterisation of the nanowires by atomic force microscopy techniques. SMA at pH 7 is slightly negatively charged; in order to adsorb the nanowires onto a mica surface, a positively charged polymer (polylysine) was deposited on the mica surface. Polylysine is known to adopt a very flat conformation on the mica surface. The surface is then washed with nanopore-deionised water. A drop of SMA-polypyrrole solution is then deposited on the surface of the mica-polylysine and then washed with nanopore-deionised water (FIG. 26).

The nanorods observed by AFM are shown in FIG. 27. The SMA association is strengthens by the presence of polypyrrole, indeed the drying did not disrupt the nanorods. The height of the nanorods is 2.5 nm, which suggests that the rods are embedded in the polylysine film. The length of the nanorods observed is about 10 microns. The nanorods are defect free due to the self-association of the shell, which can adapt perfectly to the shape of the polypyrrole core.

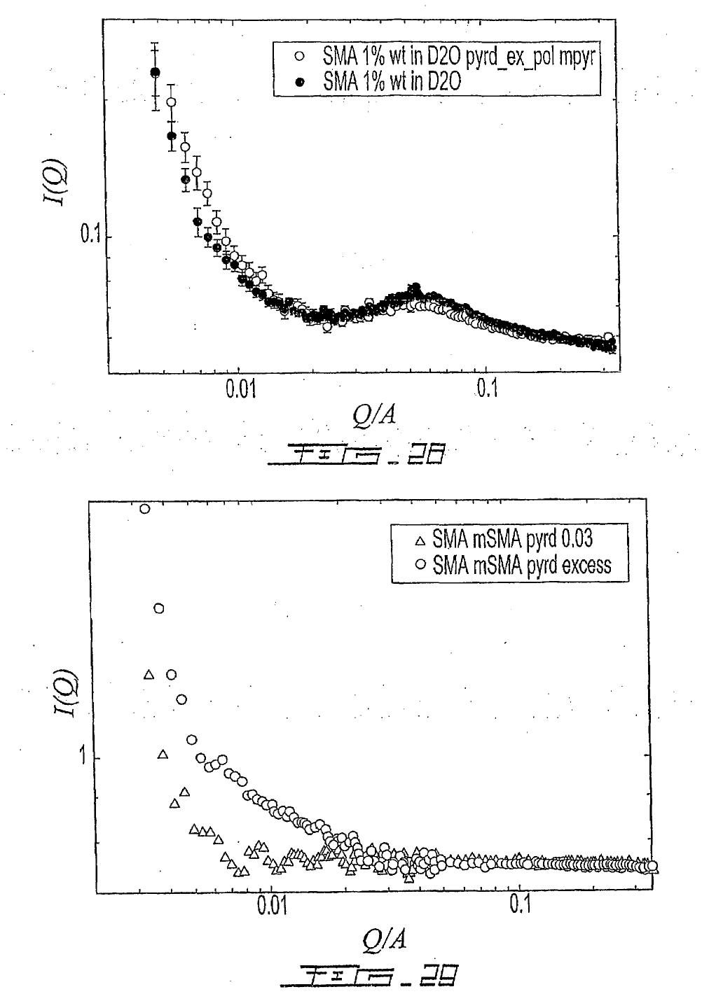

In relation to the effect of polypyrrole on SMA (Mw=40K), the scattering profile obtained for SMA when pyrrole is polymerized inside the SMA tube is very similar to the profile obtained for SMA, which shows that the structure of SMA is not altered by the presence of polypyrrole (see FIG. 28).

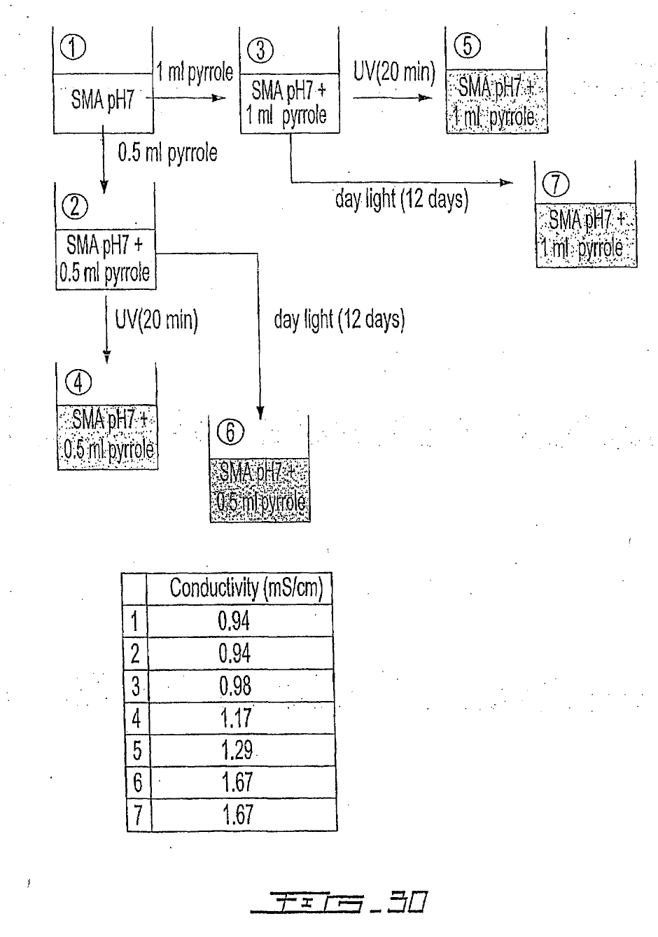

FIG. 29 illustrates neutron scattering profiles in the case of thiophene. The same behaviour is observed by neutron scattering when the tubes are filled with polythiophene when compared to nanotubes filled with polypyrrole. Therefore the same structure is obtained for the polymerisation of polythiophene and polypyrrole inside the SMA tubes.

In summary, SMA in solution at pH7 form nanotubes with a size of 4.1 nm and a hole of 2.8 nm, several micrometers long. The interior of the tube is mainly hydrophobic and exterior mainly hydrophilic. Then, the pyrrole added to the solution will be stored inside the tube and will form nanorods of polypyrrole once the initiator is added (FIGS. 26 and 27).

Neutron scattering studies of the nanotubes at pH7 have shown that the association is stable, indeed a stable signal corresponding to nanotubes interactions was obtained for temperature ranging from 15 to 75° C. Using this technique, polypyrrole nanorods may be obtained in solution. Very dense arrays of nanorods can be obtained (FIG. 26). The process is very cost effective compared to carbon nanotubes formation. The nanotubes of SMA used are defect free, as may be seen in FIG. 27, due to the weak interactions between the chains, which allows a reversible process, and are stable. The length of the nanorods is about 10 microns.

As illustrated in FIG. 30, conductivity measurements of the solution of SMA-polypyrrole show that the present method allows making both conducting and non-conducting nanorods.

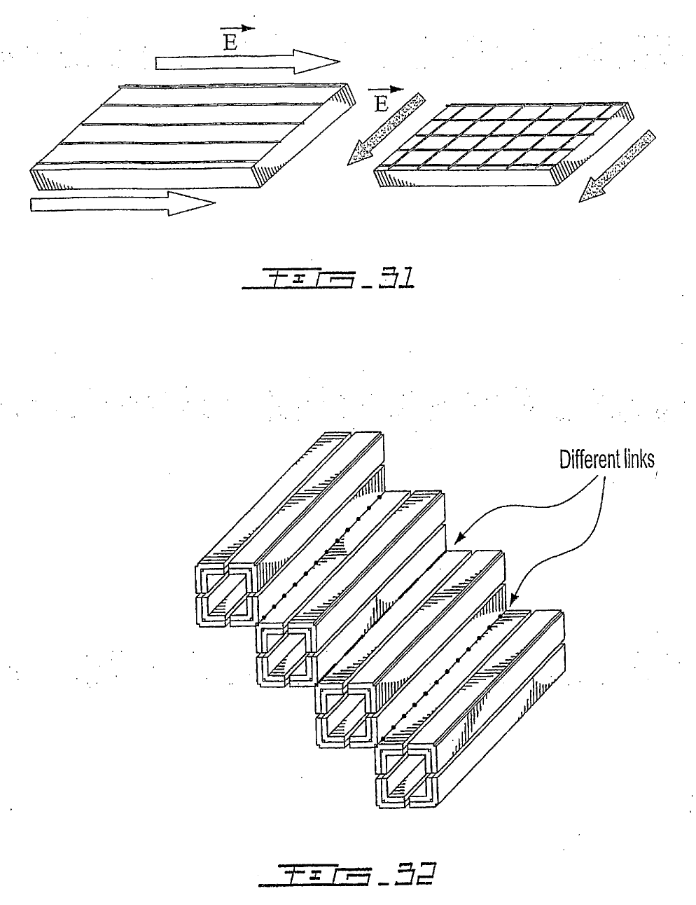

As illustrated in FIG. 31, the nanorods may also form crossbar nanorod structure by fluidic alignment as known in the art (see Y. Huang et al., Science, 2001, 291, 630) or using an electric field. They may further be metal coated to yield layers of doped (conductive) and undoped (insulating) ICP materials.

Other examples of molecules to be packed into the interior of self-assembled SMA nanotubes are highly conjugated rigid-rod type molecules, such as H—C≡C—R—C≡C—H, the length of which will be tailored to match the structure of the nanotubes by introducing groups such as R=C₆H₄—C≡C—C₆H₄ or C₆H₄—C₆H₄—C₆H₄ etc. Due to π-π interactions between such molecules and the interior of nanotubes, these are expected to lead to stable systems, a key requirement for organic electronic components. Other ICP are expected to form nanorods inside the SMA tubes.

The association between the tubes may also be modified, e.g. to alternate two types of modified tubes to be filled and polymerized with two different types of polymer. These alternating wires can be used to design small electronic devices (FIG. 32). Theoretical studies may allow the optimization of the modified tubes, which are to be used to obtain alternating wires.

Turning now to experiments with SMI, the pyrrole polymerization experiment yielded a green solution similar to the SMA solution at pH 7 but did not retain its green colour. In addition, the polymerization took place without any exposure to light. This may be due to the low pH at which the solutions were prepared, which induced polymerization by creating radicals on the pyrrole molecules. On the other hand the brown color may be explained by the acidic solution oxidizing the polypyrrole. The emulsion that was observed with SMI did not occur with SMA. It might have been caused by the nanostructure that undergoes a structural change to allow the hydrophobic parts, the phenyl groups, to orient itself towards the pyrrole. Since the polymers in solution have phenyl groups across their length they might have surrounded the pyrrole that would have been partly polymerized. This would have raised the density of the pyrrole and made it sink. Although this happened, some pyrrole did polymerize and remained in suspension due to the polymer-polypyrrole interaction. Therefore there must be a structure that sustains the polypyrrole in solution at pH 1. Thyophene, which has the same structural features as pyrrole, apart from a sulphur atom in place of the nitrogen atom, should be polymerized in the same manner as pyrrole.

From the nanostructures observed by AFM at pH 3, it seems that the milder acidic conditions did not affect the polypyrrole as seems to have occurred at pH 1. The SMI nanostructure observed is though to be a nanotube that has a similar structure to SMA in pH 7. The arguments presented for the dimer and the trimer show that a linear conformation of the nanotubes is possible, although curved section were observed. This may be due to the chirality of the carbons, R and S, which form the bond between monomers, as could be investigated by theoretical calculations on different R and S combinations to see if the polymer has a curvature. It is also possible that the conformation depends on the pH, since different structures were observed at different pH values; pH 1: rings, pH 3, nanotubes. Different pH values may prefer a conformation to another depending, which needs to be confirmed. The ionic species present in solution, in this case Cl⁻, might have an effect on the shape of the nanostructure formed, by inducing steric effects from its interaction with the positive end of the maleimide chain. Therefore varying the ionic species size would be interesting to try.

The nanostructures observed for SMI were circular with a depression at the center, about 20-30 nm in height. A possibility would be that the nanotubes form a circular shape. From a curvature measurement, the size of the expected rings can be approximated. It is possible that the discrepancy in the height of the SMI nanostructures with respect to the SMA nanostructures is caused by the stacking of the circular nanostructures. Further theoretical calculations will be useful to determine whether this interaction is possible. The calculations on these structures should also be performed using a positive charge on the terminal nitrogen on the chain along with a chlorine atom to simulate the acidic condition of the polymers. Dynamical Light Scattering (DLS) may be used to determine the size of the particles in solution.

From the foregoing, it shown that conducting nanorods can be made by filling nanotubes with monomers, followed by polymerization, the nanotubes being made from alternating copolymers of SMA (styrene maleic anhydride) or derivatives thereof, in water at room temperature. The nanotubes are several microns long and their diameter is on the order of nanometers, depending on the chemistry. The chemistry of the derivatives determines the diameter of the nanaotube. For instance nanotubes made of SMA have an outer diameter of about 4 nm, whereas those made of SMI (styrene dimethylaminopropylamine maleimide) have an outer diameter of about 10 nm. The diameter of the nanotubes can be predicted by molecular modeling. It is shown that the self-association of alternating polySMA and SMA derivatives into nanotubes occurs when the ring in the anhydride moiety is closed, either through an internal hydrogen bond (as in SMA) or a covalent bond (as in SMI). The tubes may be filled by any hydrophobic monomer that does not interfere with the nanotube structure. This allows the synthesis of nanorods made from a large variety of polymers, including conducting polymers.

Interestingly, these rods may be embedded in films and coatings, thus giving them unique properties. Moreover, these rods may be deposited on surfaces, which, for conducting nanorods above the percolation threshold, may result in conducting surface layers.

People in the art will appreciate that the method of the present invention to fabricate electrically conducting nanorods may be easily implemented industrially, since the nanotubes may be made at room temperature in aqueous solutions and the polymerization into nanorods also proceeds in water at room temperatures.

Therefore, the present method allows the production of nanorods in large volumes at low cost.

Presently square polymeric nanotubes with a size of 4.1 nm and a hole of 2.8 nm, several micrometers long may be made for example. By polymerizing monomers inside the tubes, nanorods with a diameter of about 3 nm, much smaller than any synthetic polymeric nanotubes or rods reported in the art, may be fabricated.

The nanorods may be used to make electrical nanocircuits using templates with networks of molecular strips.

In summary, the present invention provides method for synthetizing nanorods, comprising using self-assembled defect free nanotubes as template. These nanotubes are formed in water at room temperature. The nanorods are then synthesised within the nanotubes in water at room temperature. The size of the nanorods obtained is well defined due to the well-defined size of the self-assembled nanotubes. This method may be considered as a bottom-up method as opposed to top-down methods known in the art, as described in the Background section. In addition, the nanorods synthesised by this method may be doped to improve the conductivity and to obtain p and n nanowires.

The present invention describes an easy, cost effective, environmentally friendly method of obtaining well defined, densely packed, defect-free nanorods.

From the foregoing, it should now be apparent that the method of the present invention allows fabrication of intrinsically conductive polymer nanorods, which are water soluble a pH7 and which may be very long and very thin while mot stable due a locking mechanism. Moreover, the method allows fabricating high-density defect free nanorods at a relatively low cost.

Although the present invention has been described hereinabove by way of embodiments thereof, it may be modified, without departing from the nature and teachings of the subject invention as defined in the appended claims.

1. A method for fabricating intrinsically conducting polymer nanorods, comprising the steps of:
making nanotubes;
filling the nanotubes with a monomer; and
polymerizing the monomer inside the nanotubes.

2. The method according to claim 1, wherein said making the nanotubes comprises self-assembling nanotubes by alternating copolymers selected in the group consisting of SMA (styrene maleic anhydride) and derivatives thereof.

3. The method according to claim 2, wherein said self-assembling comprises self-assembling alternating polySMA and SMA derivatives into nanotubes, said self-assembling occurring when a ring in an anhydride moiety is closed, by one of through an internal hydrogen bond and a covalent bond.

4. The method according to claim 1, wherein said making the nanotubes is performed in water at room temperature

5. The method according to claim 1, wherein said making the nanotubes comprises alternating copolymers into nanotubes and stabilizing the nanotubes by one of polymer adsorption, polyelectrolyte synthesis into nanorods and chemical modification of the copolymers.

6. The method according to claim 1, wherein said making the nanotubes comprises forming nanotubes several microns long of a diameter of several nanometers.

7. The method according to claim 1, said making the nanotubes comprises making nanotubes of SMA, an outer diameter thereof being of about 4 nm.

8. The method according to claim 1, said making the nanotubes comprises making nanotubes of SMI (Styrene Maleimide), an outer diameter thereof being of about 10 nm.

9. The method according to claim 1, wherein said filling the nanotubes with a monomer comprises filling the nanotubes with an hydrophobic monomer compatible with the nanotubes.

10. The method according to claim 1, wherein said filling the nanotubes with a monomer comprises filing the nanotubes with one of pyrrole and thiophene.

11. The method according to claim 2, wherein said filling the nanotubes with a monomer comprises adding a SMA polymer to water in a solution, adjusting a pH to pH7, heating and sonicating the solution; and adding pyrrole when the solution is clear.

12. The method according to claim 2, wherein said filling the nanotubes with a monomer comprises adding a SMA polymer to water in a solution, adjusting a pH to pH7, heating and sonicating the solution; and adding pyrrole when the solution is clear, and wherein said polymerizing the monomer inside the nanotubes comprises letting the pyrrole dissolve in the SAM solution.

13. The method according to claim 12, wherein said polymerizing the monomer inside the nanotubes further comprises initiating a polymerization of pyrrole into polypyrrole by one of adding an initiator and using UV light.

14. The method according to claim 1, wherein said making nanotubes comprises molecular modeling an association conformation among alternating copolymer chains and making corresponding nanotubes.

15. The method according to claim 1, wherein the nanorods are embedded in one of an SMA matrix and a matrix of SMA derivatives.

16. Intrinsically conductive polymer nanorods comprising a nanotubes filled with a monomer, the monomer being polymerized inside the nanotubes.

17. The intrinsically conductive polymer nanorods according to claim 16, said nanotubes being made in one of SMA and SMA derivatives, said monomer being an hydrophobic monomer compatible with a structure of the nanotubes.

18. The intrinsically conductive polymer nanorods according to claim 17, said monomer being a conductive selected in the group consisting of pyrrole and thiophene, said nanorods having an outer diameter comprised between 4 and 10 nm.

19. The intrinsically conductive polymer nanorods according to claim 16, said nanorods being embedded in ones of films and coatings.

20. The intrinsically conductive polymer nanorods according to claim 16, said nanorods being deposited on surfaces.
